(19) United States
(12) Patent Application Publication
(10) Pub. No.: US 2013/0002005 A1
(43) Pub. Date: Jan. 3, 2013

(54) WHEEL BEARING FOR A VEHICLE

(75) Inventors: Peter Niebling, Bad Kissingen (DE); Roland Langer, Schwanfeld (DE); Darius Dlugai, Schweinfurt (DE)

(73) Assignee: SCHAEFFLER TECHNOLOGIES AG & CO. KG, Herzogenaurach (DE)

(21) Appl. No.: 13/583,946

(22) PCT Filed: Feb. 10, 2011
(86) PCT No.: PCT/EP2011/051951

§ 371 Date: Sep. 11, 2012

(30) Foreign Application Priority Data
Apr. 6, 2010 (DE) 102010013937.8

(51) Int. Cl. B60B 37/00; B60B 19/00; B60B 1/06

(52) U.S. Cl. 301/6.8; 301/111.03; 301/62

(57) ABSTRACT

A wheel bearing assembly is connected to a rim (400) using a self-centering tooth system (100) that can transmit play-free torque during driving and also braking events. The wheel rim (400) is axially secured by a central screw connection.

### FIELD OF THE INVENTION

The invention relates to a wheel bearing assembly for a vehicle, in particular, a motor vehicle. The invention further relates to a rim adapted to the wheel bearing assembly.

### BACKGROUND

In conventional systems, the mounting and transfer of drive torque to the wheel are realized by means of three to five mounting bolts. These common wheels, however, require an increased effort in assembly work due to the plurality of mounting bolts.

In automotive racing, these mounting bolts are replaced by carrier pins for transferring the torque. The rims are here mounted by means of a central bolt. In this racing solution, the mounting principle requires play in the area of the carrier pin to the wheel hub and the receiving holes in the wheel rim. This consequently generates noise and loosening effects of the central bolt.

DE 44 19 198 A1 describes a motor vehicle wheel. This wheel has a central part that supports the rim and is connected detachably to the wheel hub by means of a central nut screwed onto the wheel pin. To realize a lightweight structure and also the ability to quickly mount the wheel, the central part of the wheel is constructed as a wheel disk that is advantageously made from sheet steel and contacts the essentially flat end face of the wheel hub with an annular, flat mounting area surrounding a central hole. Studs mounted on the wheel hub pass through at least three pin holes distributed uniformly over the annular mounting area. The wheel disk and the wheel hub are connected to each other in a torque-locked manner.

### SUMMARY

One object of the invention is to provide a device for fixing a wheel on an axle of a vehicle, wherein this device provides a play-free transfer of torque between the axle and the wheel.

This objective and others are solved by the subject matter of each of the independent claims. Additional preferred embodiments are described in the dependent claims.

In general, the objective is met in that a self-centering tooth system, a so-called Hirth tooth system, is used that can transfer the torque during the driving and also braking operations without play. The axial securing of the wheel rim is realized by a central threaded connection.

A wheel bearing assembly for a vehicle according to the invention has a flange for the axial alignment of a rim and a rim centering device for the radial centering of the rim, wherein an axial tooth system is formed on the wheel bearing assembly, and this axial tooth system is arranged such that the axial tooth system can be brought into engagement with a tooth system that is formed in a central area of the rim.

As soon as a rim that has a tooth system that corresponds to the axial tooth system is pushed onto the end section of the axle, that is, onto the rim centering device of a vehicle axle, the tooth system formed on the rim engages in the correspondingly arranged axial tooth system on the wheel bearing assembly of the axle. As soon as the rim is pressed by means of a central threaded connection in the axial direction against the flange located on the wheel bearing assembly, a play-free engagement of the tooth system with the axial tooth system can be achieved, with which a play-free transfer of torque from the axle to the wheel (and vice versa) is guaranteed.

According to a first embodiment of the invention, the axial tooth system on the wheel bearing assembly is formed on an end face of the rim centering device. For fixing the rim, a central threaded connection, such as, for example, a central bolt on the wheel bearing assembly, can engage with its external thread in an internal thread that is formed in the rim centering device.

According to a second embodiment of the invention, the axial tooth system of the wheel bearing assembly is formed on a surface of the flange directed outward in the axial direction. In this case, the axial tooth system can be the entire surface of the flange directed outward or also only a part of the surface, that is, a ring with a smaller dimension in the radial direction than that of the entire surface. A suitable transfer of torque can be achieved when the axial tooth system is constructed in the radial inner area of the surface of the flange directed outward in the axial direction.

According to a third embodiment of the invention, the wheel bearing assembly further comprises a brake disk with a brake disk core and the axial tooth system is formed on a surface of the brake disk core directed outward in the axial direction.

According to a fourth embodiment of the invention, the wheel bearing assembly further comprises an adapter that is mounted on the flange and the axial tooth system is formed on a surface of the adapter directed outward in the axial direction.

As soon as a rim with a tooth system that is formed in the central area of the rim is mounted on a wheel bearing assembly according to the second, third, or fourth embodiment, and the tooth system on the rim is in engagement with the axial tooth system on the wheel bearing assembly, the rim can be fixed by means of a central threaded connection, such as, for example, a central nut, on the wheel bearing assembly, wherein an internal thread of a central nut engages in an external thread that can be formed on the rim centering device.

It is noted that the central area of the rim can also be shaped so that the rim can be mounted by means of a central bolt, such as according to the first embodiment, to a wheel bearing assembly according to one of the second, third, or fourth embodiments.

According to another aspect of the invention, a rim for wheel of a vehicle has a central area that is constructed such that the rim can be directed toward a flange of a wheel bearing assembly in the axial direction and toward a rim centering device of the wheel bearing assembly in the radial direction. A tooth system that can be brought into engagement with an axial tooth system formed on the wheel bearing assembly is formed in the central area of the rim.

The aspects described above and other aspects, features, and advantages of the invention can also be found in the examples of embodiments that are described below.

### BRIEF DESCRIPTION OF THE DRAWINGS

FIG. 1 is an isometric sectional view of a wheel bearing assembly according to a first embodiment together with a rim.

FIG. 2 is an isometric sectional view of a wheel bearing assembly according to a second embodiment of the invention together with a rim.

FIG. 3 is an isometric sectional view of a wheel bearing assembly according to a third embodiment of the invention together with a rim.

FIG. 4 is an isometric sectional view of a wheel bearing assembly according to a fourth embodiment of the invention.

### DETAILED DESCRIPTION OF THE PREFERRED EMBODIMENTS

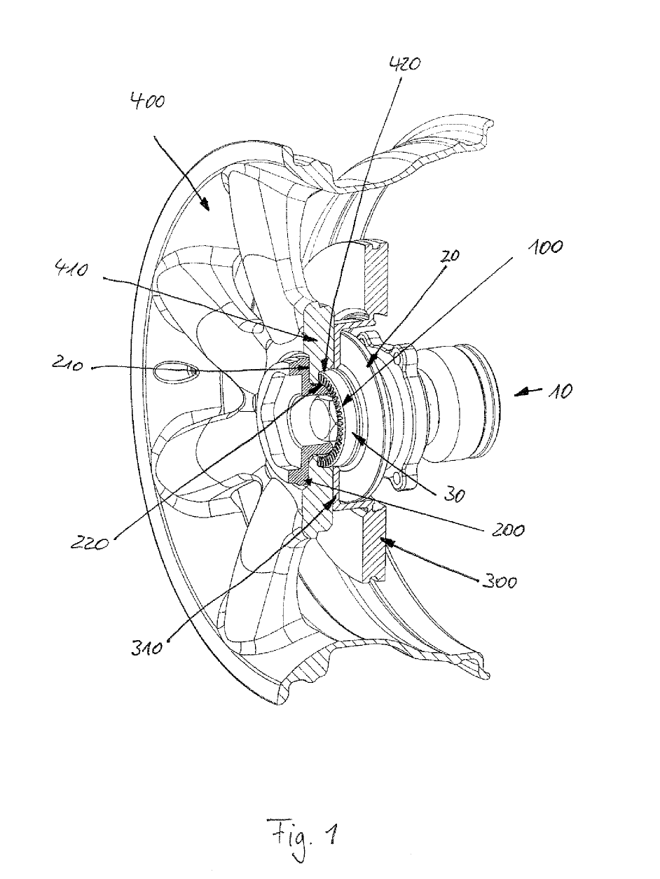

FIG. 1 shows a wheel bearing assembly with an axle 10, a flange 20, a rim centering device 30, and an axial tooth system 100 on the end surface of the rim centering device 30. The rim centering device 30 projecting outward in the axial direction is formed as the end of a tube, so that a thread can be formed on an inner wall of the rim centering device 30.

An external thread 220 of a central bolt 200 engages in the internal thread of the rim centering device 30. The bolt head of the central bolt 200 has a contact surface 210 that contacts against an outer surface of the central area 410 of a rim 400.

A brake disk 300 with a brake disk core 310 is further shown in FIG. 1. In the assembled state, the brake disk core 310 and the central area 410 of the rim 400 are fixed, that is, clamped, between the contact surface 210 of the central bolt 200 and the surface of the flange 20 directed outward in the axial direction.

The central area 410 of the rim 400 has a centering surface 420 that is in contact with the surface of the rim centering device 30 projecting outward in the radial direction when the rim is mounted. The tooth system that corresponds to the axial tooth system 100 and is in the central area 410 of the rim is not shown explicitly in FIG. 1, but according to the invention is formed in the central area 410 of the rim opposite the axial tooth system 100. Accordingly, in the assembled state the tooth system is pressed onto the rim in the axial tooth system on the rim centering device, wherein a play-free connection is provided.

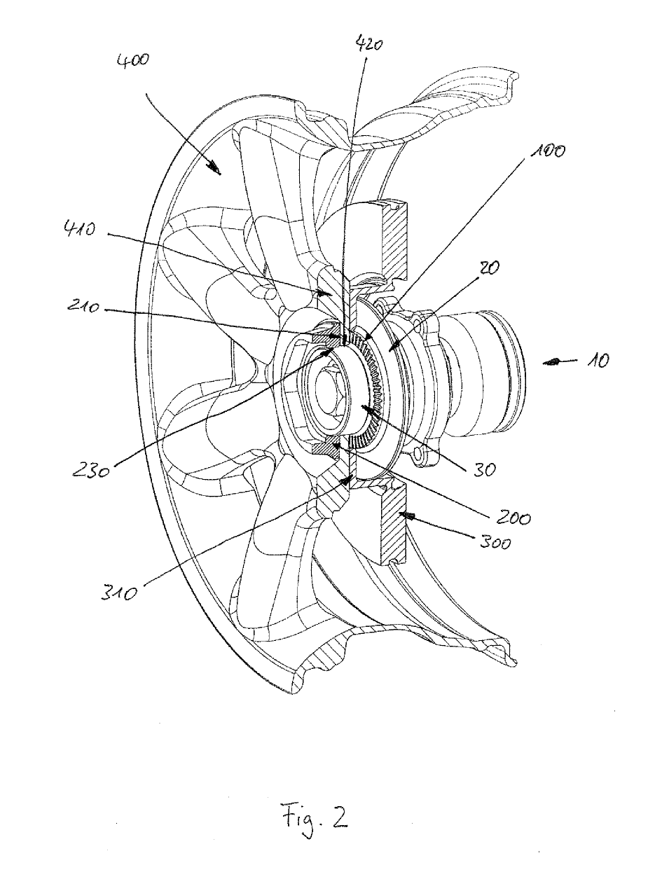

FIG. 2 shows a wheel bearing assembly with an axle 10, a flange 20, a rim centering device 30, and an axial tooth system 100, wherein the axial tooth system 100 is here arranged or formed in the surface of the flange 20 directed outward in the axial direction.

According to this embodiment, the end face of the rim centering device 30 is not formed as a tooth system, so that a central nut 200 can be used. A contact surface 210 of the central nut 200 contacts an outer area of the central area 410 of the rim 400. A thread 230 is formed on an inner surface of the central nut 200. This thread engages in an external thread that is formed on the rim centering device 30. By tightening the central nut 200, the central area 410 can be pressed against the flange 20 and thus a tooth system in the central area can be pressed into the axial tooth system 100, wherein a play-free transfer of torque can be guaranteed.

In this embodiment, the central area 410 also has a centering surface 420 for contact on the rim centering device 30. A brake disk 300 is also shown, wherein the brake disk core 310 can be fixed on the flange 20 together with the central area 410 of the rim by means of the central nut 200.

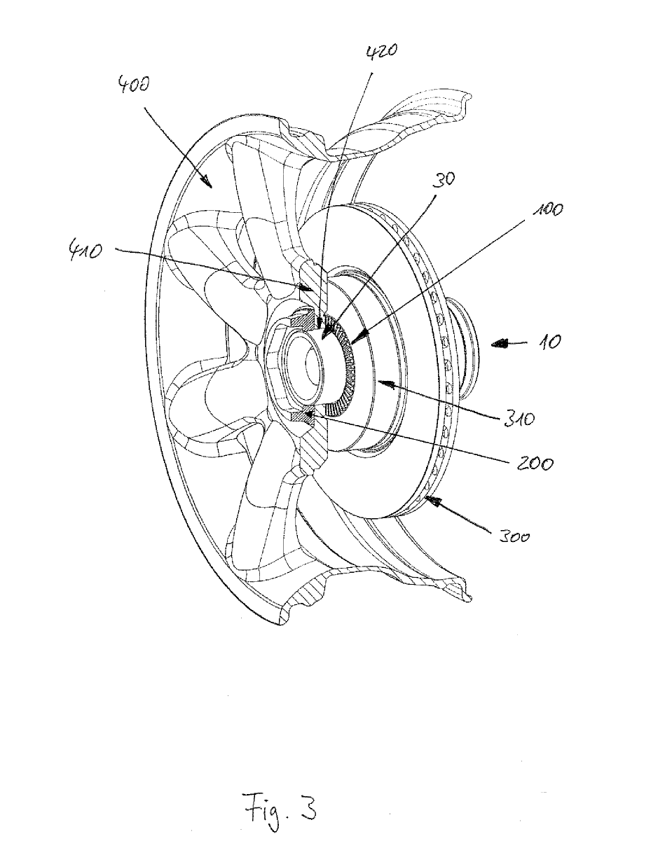

In FIG. 3, another embodiment according to the invention is shown. Here, the axial tooth system 100 is formed on the surface of the brake disk core 310 of the brake disk 300 directed outward in the axial direction. In this case, the brake disk 300 can be mounted on the axle 10 so that the brake disk core 310 is directed onto the rim centering area 30 in the radial direction.

A rim 400 with a central area 410 can now also be pushed onto the rim centering device 30, so that the centering surface 420 guarantees a radial alignment of the rim. According to this embodiment, the central area 410 and also the brake disk core are also fixed by means of a central nut 200 on the axle of the wheel bearing assembly and simultaneously a tooth system on the rim is brought into engagement with the axial tooth system on the brake disk core and presses the two tooth systems together.

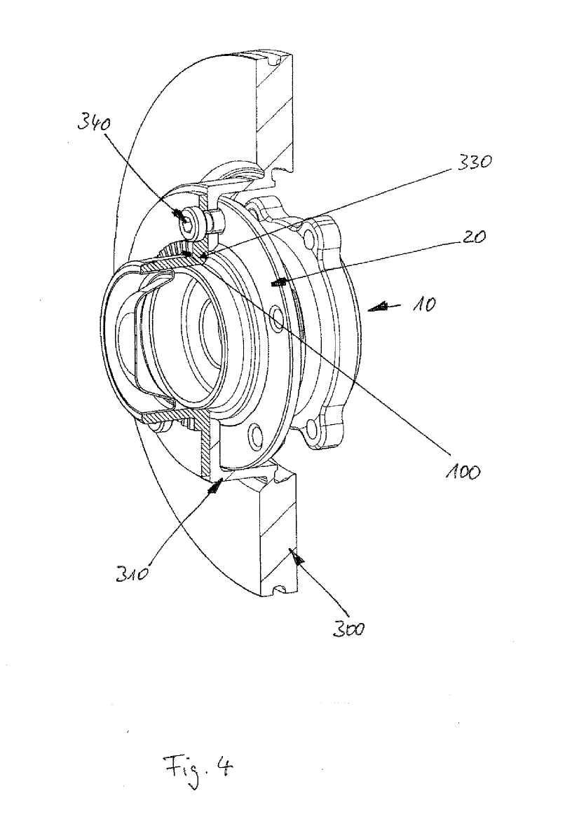

FIG. 4 shows another embodiment of a wheel bearing assembly according to the invention. Here, the axle 10 also has a flange 20 on which a brake disk core 310 of a brake disk 300 can be mounted.

This embodiment distinguishes itself in that an adapter in the form of a cylinder contacts against the outer surface of the brake disk core 310 with a flange projecting outward. The brake disk and the adapter 330 can be mounted on the flange 20 by means of pins 340. According to this embodiment, the axial tooth system 100 is provided on a surface of the adapter, in particular, the flange section of the adapter, directed outward in the axial direction. As soon as a rim is mounted on this wheel bearing assembly, a tooth system that is formed corresponding to the axial tooth system 100 on the central area of the rim can be brought into engagement with the axial tooth system 100 formed on the adapter.

The torque transfer position thus forms, according to the invention, an axial tooth system formed on the wheel flange and the wheel rim. This tooth system can be formed in the tooth partners by means of a casting or shaping process or also be mechanical processing. As described above according to the different embodiments, the axial tooth system can be formed in different positions on the wheel flange. The number of teeth and their size are dependent on the magnitude of the torques to be transferred and are designed corresponding to an intended application. The central bolt can be constructed both with an internal and also external polygonal socket, in order to allow the central threaded connection to be tightened or loosened by means of a suitable tool.

The wheel bearing assembly according to the invention and also the rim with a corresponding tooth system are conceivable for all wheel bearing generations. However, it is noted that it is important for the wheel or rim installation due to over-determination that the rim contact to the brake disk leads before the tooth system contacts the block. In this way, the rim contact on the brake disk is guaranteed. This can be achieved by a slight slope (dishing) of the rim contact surface to the outside, which causes a plate spring effect.

While the invention has been illustrated and described in detail in the drawings and the preceding description, the intent is that such illustrations and descriptions are merely illustrative or are to be used as examples and are not restrictive, so that the invention is not limited by the disclosed embodiment.

Other variations of the disclosed embodiments, in particular, the embodiments of the wheel bearing assembly, can be understood and realized by someone skilled in the art when implementing the claimed invention by studying the drawings, the disclosure, and the accompanying claims. In the claims, the word “comprising” does not exclude other elements and the indefinite article “a” or “an” does not exclude a plurality. Just the condition that certain features are named in different dependent claims does not restrict the subject matter of the invention. Any arbitrary combinations of these features can be used advantageously. The reference symbols in the claims shall not limit the scope of the claims.

### LIST OF REFERENCE NUMBERS

10 Axle
20 Flange
30 Rim centering device
100 Axial tooth system
200 Central nut/bolt
210 Contact surface
220 External thread
230 Internal thread
300 Brake disk
310 Brake disk core
330 Adapter
340 Stud
400 Rim
410 Central area
420 Centering surface

1. A wheel bearing assembly for a vehicle, comprising:
a flange for axial alignment of a rim, and a rim centering device for radial centering of the rim, an axial tooth system is formed on the wheel bearing assembly, and the axial tooth system is arranged to be brought into engagement with a tooth system that is formed in a central area of the rim.

2. Wheel bearing assembly according to claim 1, wherein the axial tooth system is formed on an end surface of the rim centering device.

3. Wheel bearing assembly according to claim 2, further comprising a central bolt for fixing the rim on the wheel bearing assembly, and an external thread of the central bolt engages in an internal thread that is formed in the rim centering device.

4. Wheel bearing assembly according to claim 1, wherein the axial tooth system is formed on a surface of a flange directed outward in an axial direction.

5. Wheel bearing assembly according to claim 1, further comprising a brake disk with a brake disk core, and the axial tooth system is formed on a surface of the brake disk core directed outward in the axial direction.

6. Wheel bearing assembly according to claim 4, further comprising an adapter that is fixed on the flange, and the axial tooth system is formed on a surface of the adapter directed outward in the axial direction.

7. Wheel bearing assembly according to claim 4, further comprising a central nut for fixing the rim on the wheel bearing assembly, and an internal thread of the central nut engages in an external thread that is formed on the rim centering device.

8. Rim for a wheel of a vehicle, comprising a central area that is formed such that the rim is alignable in an axial direction on a flange of a wheel bearing assembly and in a radial direction on a rim centering device of the wheel bearing assembly, and a tooth system is formed in a central area and the tooth system that is brought into engagement with an axial tooth system formed on the wheel bearing assembly.
